(19) United States
(12) Patent Application Publication
(10) Pub. No.: US 2018/0218370 A1
(43) Pub. Date: Aug. 2, 2018

(54) SYSTEMS AND METHODS FOR DETECTING FRAUD IN ONLINE CREDIT CARD TRANSACTIONS

(71) Applicant: MAXWELL FOREST PTY LTD, Surry Hills, New South Wales (AU)

(72) Inventor: Matthew Charles Denton, Surry Hills, New South Wales (AU)

(73) Assignee: MAXWELL FOREST PTY LTD, Surry Hills, New South Wales (AU)

(21) Appl. No.: 15/579,915

(22) PCT Filed: Jun. 9, 2016
(86) PCT No.: PCT/AU2016/050460

§ 371 Date: Dec. 5, 2017

Related U.S. Application Data
(60) Provisional application No. 62/173,273, filed on Jun. 9, 2015.

(51) Int. Cl. G06Q 20/40; G06Q 20/34; G06Q 20/38; G06Q 20/10; G06Q 20/12

(52) U.S. Cl. CPC G06Q 20/4016; G06Q 20/34; G06Q 20/12; G06Q 20/102; G06Q 20/385

(57) ABSTRACT

Described herein is a payment device comprising visible account details displayed on the payment device, a processor, a communications module, and non-transient memory. The non-transient memory stores hidden account data in respect of a hidden payment account, the hidden payment account having at least one account detail that is different to the visible account details. The non-transient memory further stores instructions which, when executed by the processor, cause the processor detect an activation event and, in response, operate the communications module to transmit the hidden account data to an electronic device.

### TECHNICAL FIELD

The present disclosure relates to systems and methods for detecting fraud in online credit card transactions.

### BACKGROUND

More and more transactions are being performed through online shopping services.

To use an online shopping service a user typically needs to submit various details to a merchant. These details include payment information such as details of a credit card account which is to be used to provide payment for the transaction.

An increasing problem with electronic transactions is credit card fraud. This can occur, for example, when a criminal obtains and uses somebody else's credit card information to complete a transaction.

Detecting and preventing credit card fraud (or fraudulent credit card transactions) is an ongoing challenge.

### SUMMARY

Described herein is a payment device comprising: means for storing hidden account data in respect of a hidden payment account, the hidden payment account having at least one account detail that is different to visible account displayed on the payment device; means for detecting an activation event; and means for, in response to detecting the activation event, transmitting the hidden account data to an electronic device.

Also described herein is a method of operating payment device, the method comprising: detecting an activation event; and in response to detecting the activation event, transmitting hidden account data stored on the payment device to an electronic device, the hidden account data being in respect of a hidden payment account, the hidden payment account having at least one account detail that is different to visible account details displayed on the payment device.

Also described herein is a payment device comprising: visible account details displayed on the payment device; a processor; a communications module; and non-transient memory, the non-transient memory storing hidden account data in respect of a hidden payment account, the hidden payment account having at least one account detail that is different to the visible account details, the non-transient memory further storing instructions which, when executed by the processor, cause the processor to perform operations comprising: detecting an activation event; and in response to detecting the activation event, operating the communications module to transmit the hidden account data to an electronic device.

In response to detecting the activation event the operations may further comprise: generating authentication data; and operating the communication module to transmit the authentication data to the electronic device.

The non-transient memory may further store the visible account details, and in response to detecting the activation event the operations may further comprise: operating the communications module to transmit the visible account details to the electronic device.

The visible account details may be valid credit card account details.

Alternatively, the visible account details may be dummy credit card account details.

The hidden account data may comprise hidden account details selected from a group comprising: an account number; an account name; an expiry date.

The hidden account data may comprise one or more payment account tokens, the one or more payment account tokens usable to retrieve hidden account details selected from a group comprising: an account number; an account name; an expiry date.

The hidden account data may further comprise security data, the security data enabling generation or recovery of a card security code associated with the hidden account.

The payment device may be a credit card.

Also described herein is a computer implemented method for operating an electronic device, the method comprising: receiving payment device data from a payment device; preparing credit card payment account details based on the payment device data; transmitting the credit card payment account details to a merchant ecommerce system to effect payment for a transaction; and transmitting a customer transaction message to a transaction recordal system, the customer transmitted transaction message comprising details in respect of the transaction.

The customer transaction message may comprise details of the transaction selected from a group comprising: a total purchase price in respect of the transaction; a description of goods/services purchased in the transaction; a merchant name; a merchant identifier; credit card payment account details.

The payment device data may comprise credit card payment account details selected from a group comprising: an account number; an account name; an expiry date, and wherein preparing credit card payment account details based on the payment device data may comprise extracting the credit card payment account details from the payment device data.

The payment device data may comprise one or more payment account tokens, and wherein preparing credit card payment account details based on the payment device data may comprise using the one or more payment account tokens to access credit card payment account details selected from a group comprising: an account number; an account name; an expiry date.

The payment device data may further comprise authentication data, and wherein the customer transaction message may further comprise the authentication data.

The computer implemented method may further comprise: entering and displaying non-payment details into visibly displayed account detail fields, the non-payment details being different to the payment account details.

The non-payment details may be received in the payment device data.

The non-payment details may be valid payment account details.

Alternatively, the non-payment details may be dummy account details.

The credit card payment account details may not be visibly entered or displayed on the electronic device.

The credit card payment account details may not be visibly displayed on the payment device.

Also described herein is an electronic device comprising: a processing unit; one or more communications interfaces; and a computer-readable storage medium having stored therein instructions which, when executed by the processor, cause the processing unit to perform operations comprising: receiving, via one of the one or more communications interfaces, payment device data from a payment device; preparing credit card payment account details based on the payment device data; transmitting, via one of the one or more communications interfaces, the credit card payment account details to a merchant ecommerce system to effect payment for a transaction; and transmitting, via one of the one or more communications interfaces, a customer transaction message to a transaction recordal system, the customer transmitted transaction message comprising details in respect of the transaction.

The customer transaction message may comprise details of the transaction selected from a group comprising: a total purchase price in respect of the transaction; a description of goods/services purchased in the transaction; a merchant name; a merchant identifier; credit card payment account details.

The payment device data may comprise credit card payment account details selected from a group comprising: an account number; an account name; an expiry date, and wherein preparing credit card payment account details based on the payment device data may comprise extracting the credit card payment account details from the payment device data.

The payment device data may comprises one or more payment account tokens, and wherein preparing credit card payment account details based on the payment device data may comprise using the one or more payment account tokens to access credit card payment account details selected from a group comprising: an account number; an account name; an expiry date.

The payment device data may further comprise authentication data, and wherein the customer transaction message may further comprise the authentication data.

The operations may further comprise: entering and displaying non-payment details into visibly displayed account detail fields, the non-payment details being different to the credit card payment account details.

The non-payment details may be received in the payment device data.

The non-payment details may be valid payment account details.

Alternatively, the non-payment details may be dummy account details.

The credit card payment account details may not be visibly entered or displayed.

The credit card payment account details may not be visibly displayed on the payment device.

Also described herein is a computer implemented method for operating a computer system, the method comprising: receiving a plurality of customer transaction messages from one or more electronic devices, each customer transaction message comprising details of a transaction; processing each customer transaction message by generating and saving a valid transaction record, the valid transaction record based on details from the submitted transaction message; receiving a plurality of verification requests from one or more financial institution systems, each verification request comprising details related to a transaction to be verified by the financial institution; for each verification request: attempting to identify a matching valid transaction record; and in response to identifying a matching valid transaction record, transmitting a transaction matched message to the financial institution system that transmitted the verification request.

Each customer transaction message may further comprise authentication data, and wherein processing each customer transaction message may further comprise: determining if the customer transaction message is authentic using the authentication data and; in response to determining that the customer transaction message is authentic, generating and saving the valid transaction record in respect of the customer transaction message.

Also described herein is a computer system comprising: a processing unit; and a computer-readable storage medium having stored therein instructions which, when executed by the processor, cause the processing unit to perform operations comprising: receiving a plurality of customer transaction messages from one or more electronic devices, each customer transaction message comprising details of a transaction; for each customer transaction message, generating and saving a valid transaction record, the valid transaction record comprising details based on the submitted transaction message; receiving a plurality of verification requests from one or more financial institution systems, each verification request comprising details related to a transaction to be verified by the financial institution; and for each verification request: attempting to identify a matching valid transaction record; and in response to identifying a matching valid transaction record, transmitting a transaction matched message to the financial institution system that transmitted the verification request.

Each customer transaction message may further comprise authentication data, and wherein for each customer transaction message the operations may further comprise: determining if the customer transaction message is authentic using the authentication data and; in response to determining that the customer transaction message is authentic, generating and saving the valid transaction record in respect of the customer transaction message.

Also described herein is a computer implemented method for operating a computer system, the method comprising: receiving a payment request, the payment request comprising transaction details in respect of a transaction for which payment is being requested; determining whether the transaction is a verifiable transaction; in response to determining the transaction is a verifiable transaction, generating and transmitting a verification request to a transaction recordal server, the verification request being in respect of the transaction and comprising data related to the transaction; receiving a verification response from the transaction recordal server; and at least partly in response to the verification response indicating the transaction is verified, causing the payment requested in the payment request to be made.

The transaction details may comprise a payment account number, and wherein determining whether the transaction is a verifiable transaction may be based on the payment account number.

A transaction may be determined to be a verifiable transaction if the payment account number is in a record of payment account numbers for which transactions can be verified.

The payment account number may comprise an issuer identification number, and wherein a transaction may be determined to be a verifiable transaction if the issuer identification number falls within a defined range of issuer identification numbers for which transactions can be verified.

The payment account number may be a hidden payment account number that is not visibly displayed on a payment device.

Also described herein is a computer system comprising: a processing unit; and a computer-readable storage medium having stored therein instructions which, when executed by the processor, cause the processing unit to perform operations comprising: receiving a payment request, the payment request comprising transaction details in respect of a transaction for which payment is being requested; determining whether the transaction is a verifiable transaction; in response to determining the transaction is a verifiable transaction, generating and transmitting a verification request to a transaction recordal server, the verification request being in respect of the transaction and comprising data related to the transaction; receiving a verification response from the transaction recordal server; and at least partly in response to the verification response indicating the transaction is verified, causing the payment requested in the payment request to be made.

The transaction details may comprise a payment account number, and wherein determining whether the transaction is a verifiable transaction may be based on the payment account number.

A transaction may be determined to be a verifiable transaction if the payment account number is in a record of payment account numbers for which transactions can be verified.

The payment account number may comprise an issuer identification number. A transaction may be determined to be a verifiable transaction if the payment account issuer identification number matches a defined issuer identification number for which transactions can be verified. A transaction may be determined to be a verifiable transaction if the payment account issuer identification number falls within a defined range of issuer identification numbers for which transactions can be verified.

The payment account number may be a hidden payment account number that is not visibly displayed on a payment device.

### BRIEF DESCRIPTION OF THE DRAWINGS

FIG. 1 is a schematic overview of systems involved in an online shopping environment.

FIG. 2 is a flowchart depicting operation of a customer electronic device when completing an online transaction.

FIG. 3 is a block diagram of a customer payment device.

FIG. 4 is a flowchart depicting operation of a customer payment device.

FIGS. 5 and 6 are flowcharts depicting operations of a transaction recordal server.

FIG. 7 is a flowchart depicting operation of a financial institution server.

FIG. 8 is a block diagram of computer system.

### DETAILED DESCRIPTION OF THE EMBODIMENTS

### Overview

Embodiments described herein relate to online shopping. Generally speaking, online shopping involves a customer using an electronic device to browse, select, and purchase goods or services from a merchant's ecommerce system.

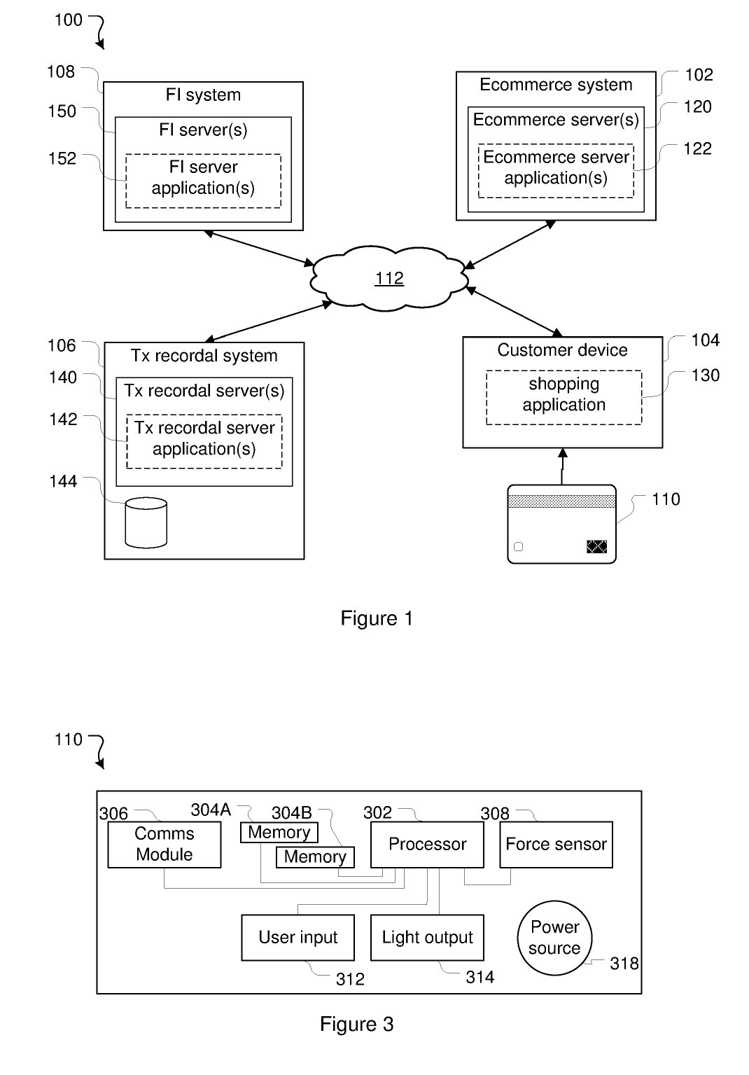

FIG. 1 provides one example of an online shopping environment 100. The systems depicted are described in detail below, but at a high level comprise a merchant ecommerce system 102, a customer electronic device 104, a transaction recordal system 106, and a financial institution system 108. These systems are interconnected by one or more telecommunications networks indicated by network 112. Also illustrated is a payment device 110 which communicates directly with the customer electronic device 104 by transmitting data thereto (and, in some instances, receiving data therefrom).

By way of overview, a customer uses the customer electronic device 104 to browse for and purchase goods/services offered for sale by a merchant through the merchant's ecommerce system 102. In order to pay for goods the customer uses the payment device 110 (which may, for example, be a credit card). The payment device 110 transmits payment device data to the customer's electronic device 104. The payment device data comprises (or facilitates retrieval of) payment account details required in order to complete the electronic transaction through the ecommerce system 102. Based on the payment device data, payment account details are prepared by the customer's electronic device 104 and submitted to the ecommerce system 102.

When the customer makes the purchase details related to the purchase are also sent to the transaction recordal system 106.

The ecommerce server 102 processes payment according to normal payment systems. This ultimately results in a payment request being sent to/received by the customer's financial institution system 108—i.e. a request for the purchase amount to be paid to the merchant's financial institution (not shown). On receiving such a payment request the customer's financial system 108 initiates, in some circumstances, a transaction verification procedure. This involves querying the transaction recordal server 106 to see if it has a valid transaction record with details that match the details of the payment request received. If a match is identified the payment request is processed as normal. If not the transaction is flagged as being fraudulent (or potentially fraudulent).

Various features and aspects will now be described in detail.

### Ecommerce System 102

Ecommerce system 102 is operated by or on behalf of a merchant. Ecommerce systems, their operation, and the services they provide are known and need not be discussed in detail.

At a high level the ecommerce system 102 comprises one or more server computers 120 which run one or more ecommerce server applications 122. The ecommerce server application(s) 122 configure the ecommerce system 102 to receive (and respond to) client requests to view goods/services being offered for sale by the merchant and requests to make purchases from the merchant.

The ecommerce server application(s) 122 also configure the ecommerce system 102 to process credit card payments for goods/services purchased by customers. Credit card payments are made by communicating/interacting with existing payment infrastructure systems (not shown). A high level description of credit card payment processing is described below.

For ease of reference, actions performed by the ecommerce server application(s) 122 which run on the ecommerce server(s) 120 will be referred to as actions performed by the ecommerce system 102.

Any appropriate server computers 120 may be used in the ecommerce system 102. One example of a computer system 800 suitable for use as a server computer 120 is described below with reference to FIG. 8.

### Credit Card Payment Processing

As noted, when a merchant receives a purchase request at its ecommerce system 102 payment is processed using normal credit card payment systems/infrastructure and protocols.

Generally speaking, the ecommerce system 102 receives credit card payment details (e.g. a card number, customer name, expiry date, CCV or other verification code etc.) via a standard ecommerce web page or application. The merchant ecommerce system 102 uses this information, along with the purchase amount, to submit an authorization request to the relevant credit card acquirer system (not shown). The acquirer system passes the request to the credit card issuer system (i.e. the customer's financial institution 108) using the relevant card network (e.g. Visa, MasterCard, etc.) as per a standard ecommerce transaction.

The customer's financial institution processes the authorization request to determine whether or not payment is authorized. If the transaction is authorized, the customer's financial institution sends an authorization message back to the acquirer system.

The acquirer system receives the authorization and transmits this authorization back to the ecommerce system 102 which proceeds with the transaction.

The ecommerce system 102 sends through approved transactions to the acquirer system to process actual payment. Sending/processing approved transactions may be performed in real time (or near-real time) or in delayed time batches. The acquirer system routes payment requests to the relevant issuer (e.g. the financial institution of the customer who made the purchase) through the credit card network.

The customer's financial institution receives the payment request from the acquirer and transfers the transaction amount back to the acquirer system. The customer's financial institution bills the customer the transaction amount.

The acquirer system receives the transfer of funds from the customer's financial institution and routes payment back to the merchant's financial institution which credits the transaction amount to the relevant account of the merchant.

### Customer Electronic Device 104

The customer electronic device 104 runs a shopping application 130. Generally speaking, the shopping application 130 provides normal ecommerce client side functionality, communicates with the payment device 110 (e.g. to receive payment device data), generates/accesses payment account details based on the payment device data, and communicates with the transaction recordal system 106 to submit transaction records.

For ease of reference, actions performed by the shopping application 130 which runs on the customer electronic device 104 will be referred to as actions performed by the customer electronic device 104.

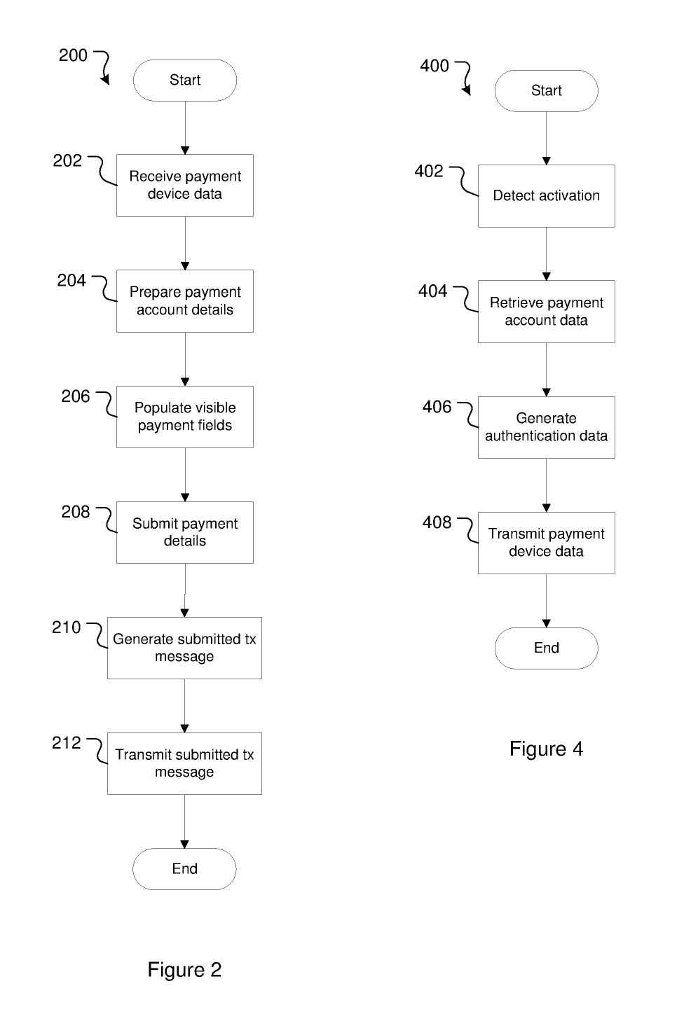

Flowchart 200 of FIG. 2 depicts the general operation of the customer electronic device 104 when completing a transaction.

As noted, the ecommerce application(s) provide normal ecommerce client side functionality allowing a customer to use their electronic device 104 to view and purchase goods/services offered by the merchant through the merchant's ecommerce system 102.

For example, when a customer wishes to purchase goods or services they select the goods/services and navigate to a checkout page or similar where payment details are entered. In order to make payment the customer activates a payment device 110 as described in further detail below. On activation, the payment device 110 transmits payment device data to the customer device 104. The payment device data are received by the customer electronic device at 202.

At 204, the customer device 104 processes the payment device data received at 202 to generate/prepare payment account details that need to be submitted to merchant's ecommerce system 102 in order to make payment.

In one embodiment the payment account details comprise details of a credit card account that is to be used to make payment (e.g. an account number, an expiry date, a card holder name/identifier, a card issuer name/identifier etc.).

In one embodiment, the actual payment account details are included in the payment device data (typically encrypted for security). In this case generation of the payment account details at 204 involves extracting the relevant details from the payment device data (and, if necessary, decrypting those details).

In an alternative embodiment, the payment device data comprises one or more payment account tokens that are used by the customer device 104 to retrieve the payment account details associated with the payment device. In this embodiment the customer electronic device 104 extracts the payment account token(s) from the payment device data and uses the payment account token(s) to retrieve the payment account details.

In one implementation, the payment account details are securely stored on the electronic device 104 itself and the payment account token(s) is/are used to access those details.

In an alternative implementation, payment account details are stored at a remote location. In this embodiment the electronic device 104 transmits the payment account token(s) to the remote location and, in response, receives the payment account details for submission to the merchant's ecommerce system 102. The remote location from which payment account details are requested/received may, for example, be a server controlled by the financial institution at which the payment account is held (e.g. financial institution system 108).

In a further implementation, different components of the payment account details may be retrieved from different locations. For example, one or more components of the payment account details may be comprised in the payment device data itself, one or more components accessed from the customer device 104 using data (e.g. token(s)) extracted from the payment device data, and/or one or more components accessed from a remote location using data (e.g. token(s)) extracted from the payment device data.

In order to make payment using the merchant's ecommerce system 102, a payment account detail that will typically be required is a card security code (e.g. a CVC, CVV, CVV2, CID, or other card security code) that is associated with the credit card payment account. In some implementations the card security code is manually provided by the user—e.g. by reading a displayed code off the payment device 110 and entering this into the relevant data entry field in the checkout process.

In other implementations, the card security code may be securely stored between a number of electronic devices. In this case retrieval/reassembly of the card security code by the customer device 104 (to enable automatic entry into the relevant field) is enabled by security data comprised in the payment device data. The security data enables generation or recovery of the card security code associated with the hidden account which can then be automatically entered into the relevant security code field by the customer device 104. Systems and methods for securely storing a record (e.g. a card security code) between a plurality of devices and retrieving a record so stored are described in PCT application PCT/AU2015/050001, filed on 6 Jan. 2015 and titled “Secure storage of data among multiple devices”, the contents of which are incorporated herein by reference in their entirety.

In addition to preparing payment account details for submission at 204, the customer electronic device 104 may automatically populate one or more visible payment fields at 206. Visible payment fields are data entry fields that form part of the checkout/payment page served by the ecommerce system 102. These fields (and the data entered into them) are visibly displayed on a screen of the customer electronic device 104 during the checkout/payment process. Visible payment fields displayed and populated may comprise, for example, an account number field, an expiry date field, a security code field, and/or other payment fields.

As described in further detail below, in one embodiment the payment device data received from the payment device 110 comprises (or facilitates retrieval of) hidden credit card payment account details—i.e. credit card account details at least some of which are not embossed, printed or otherwise displayed on the payment device 110. In this case, any visible payment fields populated by the customer device 104 are not populated using the details of the (hidden) payment account that is actually being used to make payment. Instead, the visible payment fields are populated using non-payment details—details that do not link to the account actually being used to make payment. Non-payment details may be generated/accessed by the customer device 104, or may be received from the payment device 110 in the payment device data. Further alternatively, non-payment details used to populate visible payment fields may be generic mask characters such as “*” or other mask characters.

Visibly entering non-payment details provides the user with visual feedback as to the progress of the checkout/payment progress without displaying details of the actual credit card account being used to make payment.

At 208 the customer electronic device 104 completes the checkout process by submitting the payment account details (i.e. the details of the account actually being used to make payment, which may be different to any details populated into displayed fields) to the ecommerce system 102.

When completing an ecommerce transaction with a merchant ecommerce system, the customer device 104 also logs details of the transaction with the transaction recordal system.

At 210 the customer electronic device 104 generates a customer transaction message. The customer transaction message comprises sufficient details relating to the transaction being made to allow the transaction to be identified and matched at the transaction recordal server 106 as described in further detail below.

In one embodiment the customer transaction message comprises purchase details. Purchase details can comprise one or more of: the name of the merchant from whom goods/services are being purchased; an identifier of the merchant from whom goods/services are being purchased; a transaction timestamp denoting a date and time in respect of the transaction (e.g. the approximate date/time at which the customer submitted the payment request and/or that the shopping application 130 received a confirmation from the merchant ecommerce system 102); the transaction amount; an identifier in respect of the transaction; a description of the transaction (e.g. details of goods/services purchased).

In another embodiment, a customer transaction message comprises some or all of the payment account details received in (or retrieved using) the payment device data. Payment account details may be comprised in the customer transaction message in addition to or instead of purchase details as described above. Payment account details can comprise payment account details (e.g. card number, a cardholder name, card expiry date, card issuer in respect of the credit card account used to make payment). customer transaction message

In addition, an identifier of the payment device 110 (extracted from the payment device data) may also be transmitted/communicated in the customer transaction message.

In certain embodiments, a customer transaction message also comprises authentication data received from the payment device 110. Rather than enabling identification of the transaction, the authentication data enables the transaction recordal system 106 to authenticate that the customer transaction message is valid. This is described in further detail below.

At 212 the customer transaction message is transmitted to the transaction recordal server 106.

In the embodiment depicted in flowchart 200 the customer transaction message is transmitted after submission of the payment details to the merchant's ecommerce system 102. In alternative embodiments, however, transmission of the customer transaction message may be made prior to submission of the payment details to the merchant's ecommerce system 102 (at any point after the payment device data has been received from the payment device 110).

Transmitting the customer transaction message to the transaction recordal system 106 before submitting payment details to the merchant's ecommerce system 102 may be advantageous to reduce the possibility of the transaction recordal system 106 receiving a verification request for a transaction from a financial institution system 108 before the customer transaction message of the transaction has been processed or received from the customer device 104. (Verification requests and their processing are described further below.) In one embodiment, and to further serve this purpose, the customer device 104 may transmit the customer transaction message to the transaction recordal system 106 and await a confirmation/acknowledgement from the transaction recordal system 106 that the message has been received before submitting payment details to the merchant's ecommerce system 102.

In embodiments where the customer device 104 transmits the customer transaction message to the transaction recordal system 106 before submitting payment details to the merchant's ecommerce system 102 a mechanism for informing the transaction recordal system 106 of a non-completed transaction may also be implemented. For example, if a transaction is declined after the customer transaction message has been transmitted to the transaction recordal system 106 (e.g. because of a failed credit card authorisation or a merchant refusal of the transaction) the customer device 104 may transmit a further transaction declined message to the transaction recordal system indicating that the transaction indicated by the original customer transaction message was not completed.

The shopping application 130 may communicate/interact with the ecommerce system 102 and/or the transaction recordal system 106 via WWW protocols. For example, the ecommerce application(s) may comprise (or provide the functionality of) a web browser such as Chrome, Safari, Internet Explorer, Opera (or other web browsers). The web browser allows the customer electronic device 104 to access the ecommerce system 102 and/or transaction recordal system 106 via an appropriate uniform resource locator (URL) and communicate with the ecommerce system 102 and/or transaction recordal system 106 by transmitting data using general world-wide-web protocols (e.g. http, https, ftp). The web browser functionality requests, renders and displays electronic documents that conform to a mark-up language such as HTML, XML or extensions, and may internally execute browser-executable code such as Java (applets/plugin), JavaScript, VBScript, or other forms of code.

Where the shopping application 130 uses web browser functionality to access the ecommerce system 102 or transaction recordal system 106, the ecommerce system server application(s) 122 and/or transaction recordal system server application(s) 142 will comprise a web server application (such as, for example, Apache, 2S, nginx, GWS).

Alternatively (or in addition), the shopping application 130 may communicate with ecommerce system 102 and/or transaction recordal system 106 using defined application programming interface (API) calls. In this case the ecommerce system server application(s) 122 and/or transaction recordal system server application(s) 142 will comprise an application server configured to interact with the shopping application 130 by transmitting data using those API calls.

The customer electronic device 104 may be any electronic device capable of performing the customer device functions described herein. One example of a computer system 800 suitable for use as a customer electronic device 104 is described below with reference to FIG. 8.

In one embodiment the customer electronic device 104 is a portable electronic device such as a smart phone or tablet device. Such a device will typically have (in a physically integrated manner): a touchscreen display (providing both input means and display output means); an audio output device (e.g., a speaker); an audio input device (e.g., a microphone); one or more physical input controls (e.g., physical buttons); a location monitoring module (e.g., a position sensor such as a GPS module); and a wireless communications module for direct communication with other devices such as the payment device 110 (e.g., a Bluetooth communications module such as a Bluetooth low energy (BLE) module). A phone or tablet device will comprise additional components, including those described with reference to FIG. 8 below (processing unit, memory, telecommunications network interface(s) etc.).

### Customer Payment Device 110

As noted, when making a purchase the customer uses the payment device 110. The payment device 110 is linked to/associated with one or more credit card accounts (each credit card account having associated account details) maintained by the customer's financial institution 108.

### Payment Device Hardware

In one embodiment, the payment device 110 is a small form factor device in the form of a card (e.g. a credit card) that can store data and communicate with (i.e. transmit data to and/or receive data from) another device. One such device has been described in U.S. Ser. No. 62/063,320, filed on 13 Oct. 2014 and entitled “Proximity monitoring devices and methods”, which application is incorporated by reference herein in its entirety.

The customer payment device 110 communicates with the customer electronic device 104 by receiving (and, in some instances, transmitting) data over a communication channel. In one embodiment the communication channel is a limited-range wireless connection such as a Bluetooth connection or Bluetooth low energy (BLE) connection. Alternative communications channels may be used.

As shown in FIG. 3, the customer payment device 110 generally comprises a processor 302, memory 304 for storing instructions executable by the processor 302 and data, and a wireless communication module 306 for enabling wireless communications with (i.e. sending messages to and receiving messages from) other devices, as mentioned above. In one embodiment the processor 302, memory 304 (which comprises both non-transient memory 304A such as flash memory and volatile memory 304B such as RAM), and communication module 306 are provided in an integrated microcontroller unit (MCU) such as the CC2541 or CC2540 manufactured by Texas Instruments. The communication module in this case is a Bluetooth wireless communications module compliant with Bluetooth version 4.0/4.1 (also referred to as Bluetooth Low Energy (BTLE)). In other embodiments, the communication module 306 may be configured to operate via other limited-range wireless communication channel technologies, such as ZigBee (IEEE 802.15), wireless USB, Wi-Fi, near field communications, or other personal area network communication channels.

In certain embodiments the customer payment device 110 also comprises a force sensor 308. As used herein, the term “force sensor” is used to generally describe devices/components that either sense forces (e.g., impact, pressure, compression, twisting/bending and the like) or the result of forces (e.g., acceleration) and output force signals in response thereto. In one embodiment the force sensor is an accelerometer which outputs force signals in response to the detection of acceleration. By way of example, the force sensor may be an accelerometer such as the ADXL362 manufactured by Analog Devices. The force sensor 308 may also, or alternatively, comprise a piezoelectric sensor.

In certain embodiments the customer payment device 110 further comprises a user input 312 operable by a user to interact with the device 110. The user input 312 may be a simple push-button input which, on activation by a user, sends a signal to the processor 302.

In certain embodiments the customer payment device 110 may also comprise a light output 314. In this case light output 314 is controlled by the processor 302 in order to output visual signals to a user of the device 110. By way of example, light output 314 may be a light emitting diode (LED), such as a 16-219A/S2C-AP102/3T LED manufactured by Everlight.

The customer payment device 110 also comprises a power source 318. The power source 318 is connected to and powers those components the device 110 that require power (with connections not indicated in FIG. 3 for clarity). Powered components comprise, for example, the MCU (i.e. the processor 302, memory 304, and the communications module 306), the force sensor 308 (in the event an accelerometer is used and power is necessary), and, where included, the light output 314. The voltage supplied by the power source 318 may exceed the voltage required by the MCU. In this case a DC-DC converter is used in order to step down the voltage of the power source 318 (in some cases the DC-DC convertor may be provided as part of the MCU chipset). In one embodiment power source 318 is a battery, such as a LiMn battery (for example manufactured by FDK). In some embodiments the power source 318 may comprise a rechargeable battery, either as the sole power source or in conjunction with a non-rechargeable battery. In this case the customer payment device 110 is also provided with contact points (not depicted) for connecting the customer payment device 110 to a charger to charge the rechargeable battery.

In an embodiment where the customer payment device 110 is a small form factor device, each of its components has a size that allows the components to be embedded in a small form factor device (e.g., a credit card type form factor device, or an ISO 7810 ID-1 compliant device). Alternative components to those specifically mentioned are possible.

The customer payment device 110 is configured for operation by one or more computer program modules. A computer program module may be a software module comprising computer readable instructions (and potentially data) stored in non-transient memory such as 304A. In order for the relevant functionality to be performed, a software module is loaded into transient memory such as 304B and executed by the processor 302. Computer program modules may alternatively be implemented in hardware, firmware, or in a combination of software, hardware and/or firmware.

Software and/or firmware instructions/commands and data may be transmitted to/received by the customer payment device 110 via a data signal in a transmission channel enabled (for example) by the communications module 306.

In one embodiment, the payment device 110 is an actual credit card, issued to a customer by a financial institution. In this embodiment the payment card device 110 is provided with components to enable the device 110 to be used as a payment card—e.g., a magnetic stripe with relevant encoded data, an EMV chip (EMV contact, contactless with antenna, or dual mode contact/contactless with antenna), or a combination thereof.

The components and features of the customer payment device 110 could be provided in a larger and/or alternative form-factor device. The device 110 may have other non-card form factors comprising, but not limited to, a key fob, money clip, key, lanyard, watch, pen, coin, clip, tag and buckle form factors.

### Payment Device Accounts

Payment device 110 is associated with one or more credit card accounts.

In one embodiment, the payment device is associated with two credit card accounts. These will be referred to as a visible account and a hidden account. In this embodiment each account is a valid credit card account and has associated payment account details needed to make payment using that account (e.g. an account number, expiry date, security code and the like).

The visible account is associated with visible account details printed or embossed (or otherwise displayed) on the payment device 110 in the normal manner. The visible account details may also be stored in “normal” payment card components such as a magnetic strip and/or EMV chip. The visible account is used to make payment for transactions that do not involve the shopping application 130 running on the customer device 104. For example, if a customer is manually entering account details to complete a transaction the customer reads and uses the visible account details displayed on the card. If a customer is making a purchase at a physical point of sale the visible account is used with details being accessed from the magnetic stripe or EMV chip by the POS terminal.

Visible account details may also be stored in memory (e.g. 304A) of the payment device 110. This allows for the visible account details to be accessed and transmitted to the customer electronic device 104 when payment is being made using the shopping application 130. In this case the visible account details may be used as non-payment details as described above—i.e. details that are visibly populated/displayed in the checkout process but which are not actually used to make payment.

The hidden account is associated with hidden account details that are retrievable based on hidden account data stored in memory of the device 110 (e.g. non-transient memory 304A). The hidden account data may comprise the actual account details associated with hidden account (encrypted or otherwise). Alternatively, the hidden account data may comprise one or more payment account tokens which are accessed/transmitted to the customer device 104 as required, and which are used by the customer device 104 to access/retrieve/assemble the hidden account details as described above.

At least some of the hidden account details are not displayed anywhere on the payment device 110. For example, in certain embodiments at least the account number associated with the hidden account is not printed/displayed on the payment device 110. In certain embodiments, none of the hidden account details are displayed anywhere on the payment device 110.

In certain embodiments the card security code associated with a hidden account is not stored in memory of the payment device 110 (and is not recoverable by the customer device 104 using other data stored by the payment device 110). In these embodiments the card security code is visibly displayed on the device 110. In one embodiment, the card security code associated with the hidden account and displayed on the device 110 is the same as the card security code associated with a visible account associated with the device 110.

Hidden account details are not accessible from the “normal” payment card components (mag stripe, EMV) by normal point of sale terminals.

Payment device 110 is supplied from a financial institution with any visible account details. The device 110 may also be supplied by the financial institution with the hidden account data pre-loaded. Alternatively, the hidden account data may be uploaded to the device 110 via the communications module (and/or modified) after supply.

In an alternative embodiment only the hidden account details associated with payment device 110 are in respect of an active credit card account. In this case any visible account details associated with (e.g. displayed on) the payment device 110 do not link to a valid account and cannot be used to make payment. The visible account details can, however, still be stored/transmitted to the shopping application 130 be entered as non-payment details.

### Payment Device Operation

Operation of the payment device 110 will be described with respect to flowchart 400 of FIG. 4.

As described above, when using the shopping application 130, a customer will reach a point where they wish to check-out/purchase the goods or services selected. In order to complete the purchase the ecommerce server 102 will require payment details to be submitted. In order to submit payment details the customer activates the payment device 110.

At 402 the purchase device 110 detects an activation event.

An activation event may be the result of various interactions with the payment device 110. For example, interaction with a user input 314 (e.g. pressing a button on the device 110) may be an activation event.

Alternatively, an activation event may be a predetermined physical action made with or to the payment device 110—for example a tap or series of taps made with or on the payment device 110, a swipe motion with the payment device 110, rotation or twisting of the payment device 110, or a combination of such actions. In this case the payment device 110 stores one or more activation signatures in memory (e.g. 304A), each signature defining sensor readings which, if detected, will be interpreted as an activation event. For example, an activation signature may involve sensing (via the force sensor 308) that the device 110 is being held or has been moved in a predetermined fashion, or that one or more tap events have been performed with or on the device 110. To detect an activation gesture the force sensor 308 senses motion and provides data in respect of the motion to the processor 302. The processor 302 analyses the sensor output and determines whether the data corresponds to an activation signature.

Further alternatively, an activation event may be the receipt of an activation communication/signal by the payment device 110 from the customer device 104 (the activation communication/signal generated, for example, by the shopping application 130 on user activation of a “pay now” control or similar).

At 404, on detection of an activation event, the payment device processor 302 retrieves one or more sets of account data from memory (e.g. memory 304A).

In one embodiment a single set of account data only is accessed and transmitted to the customer electronic device 104. In this case the account data is the data associated with the hidden account and will be used by the customer device 104 to try and make payment.

In another embodiment two sets of account data are accessed by the payment device 110 and transmitted to the customer device 104. In this case the hidden account data are sent as payment account data and a second set of data (which may be the visible account details or a second set of hidden account data) are transmitted as non-payment details for visible entry into payment fields.

In certain embodiments the payment device 110 is also configured to generate authentication data to be included in the payment device data transmitted to the customer electronic device 104 (and from the customer electronic device 104 to the transaction recordal system 106). In these embodiments the processor 302 generates authentication data at 406.

The purpose of the authentication data is to permit the transaction recordal system 106 to verify that the payment device 110 was used in the transaction. In one embodiment the authentication data is a one-time password (OTP) generated by the processor 302 of the payment device 110. Any appropriate OTP implementation may be used to allow the transaction recordal system 106 to check and verify the OTP received in a submitted transaction message was (or was very likely to have been) generated by the payment device 110 that matches other details of the submitted transaction message (e.g. a device identifier, account details, etc.). For example a time-based OTP implementation, a hash chain based OTP implementation, or an alternative OTP implementation may be used.

In one embodiment a time-based OTP implementation is adopted. In this embodiment the payment device 110 generates a OTP based on a time value. The time value may be generated by the device 110 itself or may be transmitted to the payment device 110 from the user electronic device 104. In certain embodiments, particularly if a clock maintained by the payment device 110 is not particularly accurate, the time value which the device 110 uses to calculate the OTP is also sent to the customer electronic device 104 in the payment device data.

The payment device 110 may also transmit a unique identifier of the payment device 110. This may, for example, be a Bluetooth MAC address (where device 110 transmits via Bluetooth). Alternatively, the device 110 may be supplied with a unique identifier on manufacture/shipping by the financial institution. Any other unique identifier may be used.

At 408 the payment device 110 operates the wireless communication module 306 to transmit the payment device data to the customer electronic device 104. The payment account data comprise the one or more sets of account data retrieved at 404, the authentication data generated at 406 (if used), and a payment device identifier (if used).

Communicating payment device data to the customer electronic device 104 may involve an authentication process whereby the customer electronic device 104 authenticates the payment device 110.

Communications between the payment device 110 and customer electronic device 104 may be secured (e.g. via encryption) to prevent or at least inhibit a third party from deciphering any intercepted communications.

### Transaction Recordal System 106

The transaction recordal system 106 comprises one or more server computers 140 running one or more transaction recordal server applications 142. The transaction recordal server application(s) 142 configure the transaction recordal server computer(s) 140 to perform two general functions: processing customer transaction messages received from customer electronic devices 110 and processing verification requests received from financial institution systems 108.

As described above, customer transaction messages are communicated to the transaction recordal system 106 from the customer's electronic device 104 during the completion of a purchase. Verification requests are communicated to the transaction recordal system 106 from the financial institution system 108 when the financial institution system 108 receives a credit card payment request from normal credit card payment channels. Normally, a customer transaction message in respect of a transaction will (barring network/device failures) be received by the transaction recordal system 106 before a verification request for that transaction is received. As described above, the likelihood of this occurring can be increased by the customer device 104 communicating the customer transaction message to the transaction recordal system 106 before submitting payment details to the merchant ecommerce system 102, or guaranteed by operating the customer device 104 to only submit payment details to the merchant ecommerce system 102 once confirmation that the customer transaction message in respect of the transaction has been received by the transaction recordal system 106.

For ease of reference, actions performed by the transaction recordal server application(s) 142 which run on the transaction recordal server(s) 140 will be referred to as actions performed by the transaction recordal system 106.

### Processing Customer Transaction Messages

When a customer makes an ecommerce purchase using the shopping application on their customer device 104 and their payment device 110, the customer device 104 communicates a customer transaction message to the transaction recordal server 106.

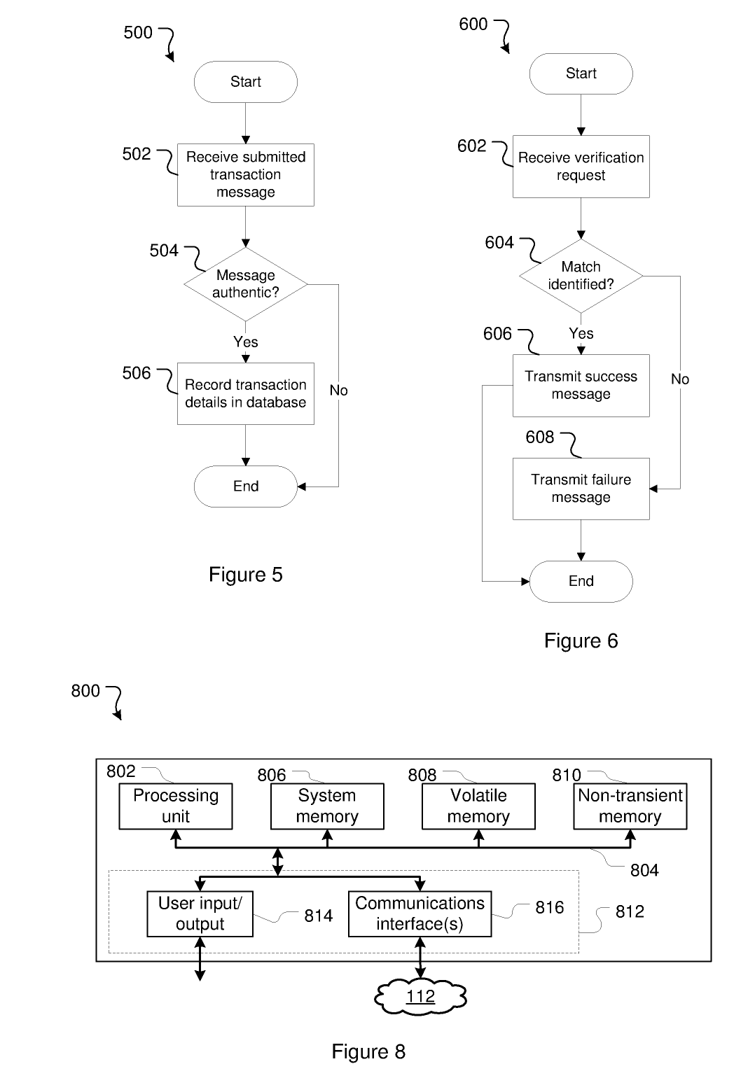

Processing of customer transaction messages by the transaction recordal system 106 will be described with reference to the flowchart 500 of FIG. 5.

At 502 the transaction recordal system 106 receives a customer transaction message from a shopping application 130 operating on a customer electronic device 104.

As described above, in certain embodiments a customer transaction message comprises authentication information generated by the payment device 110 used by the customer to complete the purchase. In this case the transaction recordal server 104 uses the authentication information to determine (at 504) whether or not the customer transaction message is authentic.

Where authentication relies on an OTP implementation, the check will generally involve the transaction recordal server 106 comparing the OTP received in the customer transaction message against an expected OTP that the transaction recordal server 106 expects to accompany a customer transaction message. The expected OTP may be generated by the server 106 based (for example) on details that should be unique to the payment device 110 that has been used (e.g. an account number, a payment device identifier, or other details).

If, at 504, the customer transaction message is determined to be authentic, a valid transaction record is generated (using data from the customer transaction message) and written to a database at 506 (e.g. database 144). The precise details comprised in a transaction record (and the data structure(s) in which those details are stored) will depend on the particular implementation.

If, at 504, the customer transaction message is determined not to be authentic a valid transaction record is not created. In one embodiment a non-authentic customer transaction message is ignored and the process ends. In an alternative embodiment data from a non-authentic customer transaction message may still be recorded (though not as a valid transaction record) and analysed/acted upon as being representative of fraudulent activity.

In alternative embodiments, authentication of a customer transaction message may not be performed. In this case, rather than authenticating each individual customer transaction message received, the transaction recordal server 106 may authenticate the shopping application 130 as part of the connection process between the shopping application 130 and server application 142.

As described above, in certain embodiments the customer device 104 communicates/transmits the customer transaction message to the transaction recordal system 106 before submission of the payment details to the merchant ecommerce server 102. In this embodiment the possibility exists that once the payment details have been submitted the transaction will be declined (either as part of the payment processing or by the merchant itself). To account for this the transaction recordal system 106 may from time to time receive transaction declined messages from customer devices 104. When a transaction declined message is received the transaction server 106 identifies the valid transaction record that was created in respect of that transaction and removes or otherwise flags that record as a transaction that did not actually occur.

### Processing Verification Requests

As described above, as part of the normal processing of a credit card transaction the financial institution that issued the card is sent a payment request to effect payment. In certain cases the financial institution system 108 initiates a transaction verification procedure as part of processing payment requests. This involves the financial institution system 108 sending a verification request to the transaction recordal system 106.

Receipt and processing of verification requests by the transaction recordal system 106 will be described with reference to flowchart 600 of FIG. 6.

Communications between the transaction recordal system 106 and financial institution 108 are secured in order to prevent (or at least deter) man-in-the-middle attacks.

At 602 the transaction recordal system 106 receives a verification request from a financial institution system (e.g. 108). The verification request comprises information regarding a transaction which the financial institution system 108 is being asked to effect payment for. In one embodiment the verification request comprises an identifier of the payment account (e.g. the payment account number, a name of the account holder or other identifier), the total transaction amount, and the transaction time. Additional details may also be included, for example a transaction identifier, a merchant identifier etc.

At 604 the transaction recordal server 140 performs a check to see whether a valid transaction record with details matching details in the verification request exists.

The data used to identify a match will depend on the details in the verification request received from the financial institution system 108 and details stored by the transaction recordal system 106 in valid transaction records. Typically a match will be based on payment account identifier, the total transaction amount, and the transaction time. More generally, however, matching may be performed on any appropriate data, for example on one or more of: a total transaction amount; account details (account number, expiry date, name); a transaction timestamp; a transaction identifier; merchant details (e.g. a merchant identifier, name, and/or other merchant details).

Where a timestamp is used to assist in identifying a match exact correspondence between a transaction time received in the verification request and a transaction time recorded in the database (initially received in a transaction record) may not be required. Rather, a time difference threshold may be used—i.e. provided the two times are within the threshold difference they will be considered to be matching. This difference accounts for the possibility of the time being recorded by the merchant ecommerce system 102 and the time included in the customer transaction message being different. The threshold difference may be set to any appropriate difference—a set number of seconds (e.g. 2 seconds) or minutes (e.g. 2 minutes).

If, at 604, a matching database record exists, the transaction recordal server 140 transmits a transaction matched message back to the financial institution system 108 at 606.

If, at 604, no matching database record exists, the transaction recordal server 140 transmits a no-match message back to the financial institution system 108 at 608.

The process then ends.

In certain embodiments, the transaction recordal system 106 may take additional verification steps (not shown) if no database record matching the verification request is identified at 604. For example, predefined alternative verification circumstances may be defined which, if met, result in the transaction recordal system 106 attempting to authorise a transaction in a different manner. One such alternative verification circumstance may be where a verification request with a transaction time very close to the current time is received from the financial institution system 108. In this case it may be possible that the normal payment processing and verification request have overtaken the customer transaction message. Where an alternative verification circumstance is identified, the transaction recordal system 106 sends a manual confirmation request to the customer electronic device 104, e.g. via an SMS, email, instant message, or other communication). In this case the transaction recordal system 106 maintains a record of customers who use the shopping application 130—e.g. account numbers and device/customer contact details. The manual confirmation request comprises details of the transaction and asks the customer to confirm (or otherwise) that the transaction was made by the customer. If a confirmation is received the transaction is considered valid and a transaction matched message is sent to the financial institution system 108. Conversely, if no response is received (or a deny response is received) the transaction is not valid and a non-match message is sent to the financial institution system 108.

The transaction recordal system 106 has been depicted as a separate/independent system to the financial institution system 108. In some embodiments, however, the transaction recordal system 108 may be operated by the financial institution. In this case the transaction recordal system 106 may still be a separate system to the financial institution system 108, or may be a part of that system. Even if the transaction recordal system 106 is part of/operated by the financial institution 108, payment requests (generated via normal payment systems) and payment details messages (generated by the shopping application 130 running on a customer electronic device 104) will be received from different sources/via different channels.

Any appropriate server computers 120 may be used in the transaction recordal system 106. One example of a computer system 800 suitable for use as a server computer 140 is described below with reference to FIG. 8.

### Financial Institution System 108

The financial institution system 108 comprises one or more financial institution server computers 150 running one or more financial institution server applications 152. The financial institution server application(s) 152 perform various financial institution functions comprising authorizing and clearing (paying) transaction requests received through normal credit card payment channels.

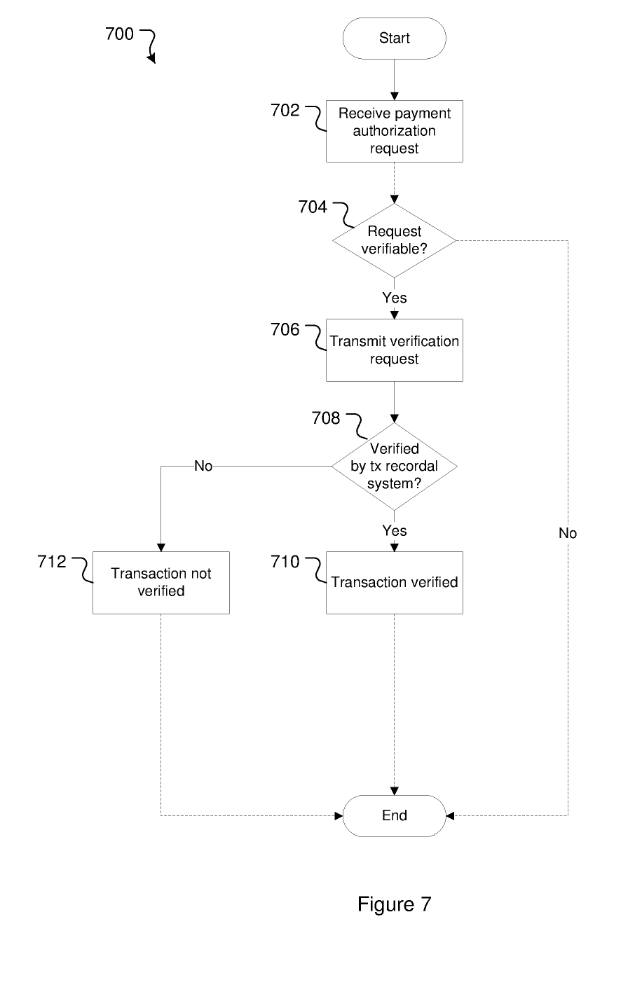

For certain transactions the financial institution server application(s) 152 also seeks verification of the transaction by using the transaction recordal system 106. Operation of the financial institution server application(s) 152 to verify payment requests will be described with reference to the flowchart 700 of FIG. 7.

For ease of reference the operations performed by the financial institution server application(s) 152 will be referred to as operations performed by the financial institution system 108.

At 702 the financial institution system 108 receives a payment request in respect of a transaction. As discussed above, this request is received through normal payment channels—e.g. from an acquirer.

The financial institution system 108 may perform a variety of “normal” processing steps on receipt of the payment request that are not directly related to the present embodiments. The possibility of such processing is indicated by the dashed line joining 702 and 704.

At 704 (and presuming that processing of the payment request has not been finalized based on other/normal processing) the financial institution system 108 performs a check to determine whether or not the payment request relates to a verifiable transaction. As used herein, a verifiable transaction is one that is capable of being verified by the transaction recordal system 106.

In one embodiment a payment request is determined to relate to a verifiable transaction based on the account number associated with the request. In this instance the financial institution system 108 maintains a record of verifiable account numbers (a verifiable account number being an account number for which transactions can be verified using the transaction recordal system 106).

The record of verifiable account numbers may be a list of individual account numbers for which transactions can be verified using the transaction recordal system 106. In this embodiment the check at 704 is performed by determining whether the account number in the received payment request appears in the list of verifiable account numbers. If so the transaction related to the payment request can be verified using the transaction recordal system 106. If not the transaction related to the payment request cannot be verified using the transaction recordal system 106.

Alternatively, the record of verifiable account numbers may be based on issuer identification numbers (IINs, also known as bank identification numbers (BINs)). In this embodiment the check at 704 is performed by extracting the IIN from the account number in the received payment request and determining whether the extracted IIN is a verifiable IIN—i.e. an IIN in respect of which transactions can be verified. Determining whether the extracted IIN is a verifiable IIN may comprise comparing the extracted IIN to a list (or other data structure) of individual verifiable IINs: if a match is identified the transaction is determined to relate to a verifiable transaction. In addition, or alternatively, determining whether the extracted IIN matches a verifiable IIN may comprise comparing the extracted IIN to one or more ranges of verifiable IINs: if the extracted IIN falls within one of the defined IIN ranges the transaction related to the payment request can be verified using the transaction recordal system 106. If the extracted IIN is not a verifiable IIN the transaction related to the payment request cannot be verified using the transaction recordal system 106.

If, at 704, the transaction is not identified as one can be verified using the transaction recordal system 106, the process ends. In this case the payment request is approved or denied based on normal payment request processing performed by the financial institution system 108.

At 706, in response to determining that the transaction can be verified using the transaction recordal system 106, the financial institution system 108 generates and sends a verification request to the transaction recordal system 106. The details included in the verification request comprise details extracted from the payment request received by the financial institution server 108 at 702, for example one or more of: the total transaction amount; account details (account number, expiry date, security code, name); a transaction timestamp; a transaction identifier; merchant details.

At 708 the financial institution system 108 receives and checks the response to the verification request received from the transaction recordal system 106.

If a transaction matched message (i.e. a message indicating that verification was successful) is received from the transaction recordal system 106 the transaction in the payment request has been verified by the transaction system 106 (708).

If, at 708, a non-match message is received from the transaction recordal system 106 the transaction in the payment request has not been verified.

Following the transaction being verified (at 710) or not verified (at 712) the financial institution system 108 continues normal processing of the payment request based on the verification or lack thereof. Where the transaction is verified at 710 further processing will typically involve (subject to other checks that may be performed as part of the normal processing) the financial institution 108 causing the payment requested in the payment request to be made. Where the transaction is not verified at 712 further processing will typically involve (again subject to other checks that may be performed as part of the normal processing) the financial institution 108 denying payment and/or taking action in respect of what is treated as a fraudulent transaction.

It should be noted that verification (or otherwise) by the transaction system 106 is not necessarily a final verification. Rather, verification (or otherwise) by the transaction system 106 is data that can be used by the financial institution system 108 as part of its broader transaction approval process. For example, a transaction could be matched (and verified) by the transaction system 106 yet still declined due to other checks/criteria implemented by the financial institution system 108. Alternatively, a transaction may not be matched (and not verified) by the transaction system 106 yet still permitted due to other checks/criteria implemented by the financial institution system 108.

As described above, in one embodiment the payment device 110 is a credit card associated with hidden account details (stored on memory and accessed only in transactions made via the shopping application 130) and associated with visible account details (displayed on the device 110 as per normal credit cards). In this embodiment the financial institution issues the card so that both sets of account details are valid. The visible account details are issued so that transactions made using the visible account are not determined to be verifiable at 704. The hidden account details, however, are issued so that transactions made using the hidden account are determined to be verifiable at 704 (e.g. by recording the hidden account number as verifiable account number or by issuing the hidden account number within one of the defined IIN ranges).

The customer can use the payment device 110 either to complete purchases through the shopping application 130 of their electronic device 104, or through other means (e.g. point of sale terminals at merchant stores, telephone transactions, or through ecommerce applications/websites other than shopping application 130).

For transactions that are not made through the shopping application 130 the visible account details are used. As these transactions are not made through the shopping application 130 no record of the transaction is logged with the transaction recordal system 106. When the financial institution system 108 receives a payment request from the acquirer no verification of the transaction is requested from the transaction recordal system 106 (as at 704 the visible account number associated with the payment request is not recognised as an account for which transactions can be verified using the transaction recordal system 106).

Conversely, where the customer completes a transaction using the shopping application 130 the hidden account details are used. As the transaction is made through the shopping application 130 a record of the transaction is logged with the transaction recordal system 106. When the financial institution system 108 receives a payment request from the acquirer the account number is identified (at 704) as one for which transactions can be verified using the transaction verification system and verification is sought.

Any appropriate server computers 150 may be used in the financial institution system 108. One example of a computer system suitable for use as a server computer 150 is described below with reference to FIG. 8.

### Alternative Embodiments

In one embodiment, payment device 110 may be a card that is dedicated for use with online shopping using shopping application 130. In this case the device may not have any visible account details displayed on it, or may have dummy visible account details (e.g. a generic “0000 0000 0000 0000” account number and other account details that cannot actually be used to effect payment).

In this embodiment all transactions performed with the payment device 110 are made using hidden account details associated with the device 110. As described above, visible payment fields on a checkout/payment page may be populated using masked characters or non-payment details (either those that are visible on the device 110 or alternative non-payment details). All transactions made using the device 110 are logged with the transaction recordal server 106, and (if properly made) can be verified by the customer's financial institution system 108.

The embodiments above have been described with respect to performing a verification check at the payment request stage of a typical credit card payment processing. The specific manner in which card transactions are processed may be different and/or change over time. The features described herein, and in particular the verification step performed by a financial institution on receiving a request to authorize payment for a transaction, can be adapted to be used with different payment processes.

### Computer System

In the embodiments described above the various features and functions are provided by computer systems. The merchant ecommerce system 102 comprises one or more ecommerce servers 120 which are (or are provided by) one or more computer systems. The transaction recordal system 106 comprises one or more transaction recordal servers 140 which are (or are provided by) one or more computer systems. The financial institution system 108 comprises one or more financial institution severs 150 which are (or are provided by) one or more computer systems. The customer electronic device 104 is a computer system.

FIG. 8 is a block diagram of one example of a computer system 800 that may be used. The architecture depicted in FIG. 8 may be implemented in a variety of computer processing systems, for example a laptop computer, a netbook computer, a tablet computer, a smart phone, a desktop computer, a server computer, games console, media player etc.

Computer system 800 has a processing unit 802, which may comprise a single computer-processing device (e.g., a central processing unit, graphics processing unit, or other computational device), or may comprise a plurality of computer processing devices. In some instances processing is performed solely by the processing unit 802, however, in other instances processing may also, or alternatively, be performed by remote processing devices accessible and useable (either in a shared or dedicated manner) by the computer system 800.

Through a communications bus 804 the processing unit 802 is in data communication with one or more machine-readable storage (memory) devices that store instructions and/or data for controlling operation of the customer electronic device 104. In this instance, the computer system 800 comprises a system memory 806 (e.g., a BIOS), volatile memory 808 (e.g., random access memory such as one or more DRAM modules), and non-volatile/non-transient memory 810 (e.g., one or more hard disk or solid state drives).

Computer system 800 also comprises one or more interfaces, indicated generally by 812, via which the computer system 800 interfaces with various components, other devices and/or networks. Generally speaking, other components/devices may be physically integrated with the computer system 800, or may be physically separate. Where such devices are physically separate from the computer system 800, connection between the device and the computer system 800 may be via wired or wireless hardware and communication protocols, and may be direct or indirect (e.g. networked) connections.

Wired connection with other devices/networks may be by any appropriate standard or proprietary hardware and connectivity protocols. For example, the computer system 800 may be configured for wired connection with other devices/communications networks by one or more of: USB; FireWire; eSATA; Thunderbolt; Ethernet; Parallel; Serial; HDMI; DVI; VGA; AudioPort. Other wired connections are possible.

Wireless connection with other devices/networks may similarly be by any appropriate standard or proprietary hardware and communications protocols. For example, the computer system 800 may be configured for wireless connection with other devices/communications networks using one or more of: infrared; Bluetooth (e.g., Bluetooth 4.0/4.1, also known as Bluetooth low energy); Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Generally speaking, the devices or systems to which the computer system 800 connects—whether by wired or wireless means—allow data to be input into/received by the computer system 800 for processing by the processing unit 802, and data to be output by the computer system 800. Example devices are described below. However, it will be appreciated that not all computer systems 800 will comprise all mentioned devices, and that additional and alternative devices to those mentioned may well be used.

For example, the computer system 800 may comprise or connect to one or more input devices by which information/data is input into (and received by) the computer system 800. Such input devices may comprise physical buttons, alphanumeric input devices (e.g., keyboards), pointing devices (e.g., mice, track-pads and the like), touchscreens, touchscreen displays, microphones, accelerometers, proximity sensors, GPS devices and the like. The computer system 800 may also comprise or connect to one or more output devices controlled by the computer system 800 to output information. Such output devices may comprise devices such as indicators (e.g., LED, LCD or other lights), displays (e.g., LCD displays, LED displays, plasma displays, touch screen displays), audio output devices such as speakers, vibration modules, and other output devices. The computer system 800 may also comprise or connect to devices which may act as both input and output devices, for example memory devices (e.g., hard drives, solid state drives, disk drives, compact flash cards, SD cards and the like) which the computer system 800 can read data from and/or write data to, and touch-screen displays which can both display (output) data and receive touch signals (input).

Computer system 800 may also connect to communications networks (e.g., the Internet, a local area network, a wide area network, a personal hotspot, etc.), such as the network 112, to transmit data to and receive data from networked devices, which may be other computer processing systems.

Operation of the computer system 800 is enabled by one or more computer program modules or applications which configure the computer system 800 to receive, process, and output data. Generally speaking a program module or application comprises computer readable instructions and data which are stored in non-transient memory 810. When required the instructions/data are read into volatile memory 808 and executed by the processing 802.

One such computer program module/application will be an operating system. By way of example: where the customer electronic device 104 is a smart phone or tablet type computing system it may run an operating system such as Apple iOS, Android, BlackBerry, Windows Phone/Mobile; where the customer electronic device 104 is a netbook computer, laptop computer, desktop computer it may run an operating system such as Microsoft Windows, Max OS; sever computer systems (e.g. 120, 140, 150) may run an operating system such as Unix, Linux, Microsoft Windows Server, Max OS X server.

A computer system 800 is also provided with additional computer program modules/applications to perform additional processing and provide additional functions (e.g. the processing/functions described above). For example, and as described above, the merchant ecommerce server(s) 120 run one or more ecommerce server applications 122, the transaction recordal server(s) 140 run one or more transaction recordal server applications 142, the financial institution server(s) 150 run one or more financial institution sever applications 152, and the customer electronic device 104 runs a shopping application 130. The shopping application 130 may be downloaded and installed from a suitable application distribution platform such as an application store/market place, e.g., Apple's App Store (for iOS), Google Play (for Android) or other enterprise stores. Alternatively the shopping application 130 may be pre-loaded on the device 104.

It will be appreciated that FIG. 8 is does not illustrate all functional or physical components of a computer system 800. For example, no power supply or power supply interface has been depicted, however the computer system 800 will carry one or both of these.

It will also be appreciated that the particular type computer system will determine the actual hardware components and configuration. Alternative computer systems may have additional, alternative, or fewer components than those depicted, combine two or more components, and/or have a different configuration or arrangement of components. For example, a server computer will typically have greater processing, memory and communications capabilities than a desktop computer or portable electronic device such as a phone or tablet.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

As used herein, the term “comprise” and variations of the term, such as “comprising”, “comprises” and “comprised”, are not intended to exclude other features, components, integers or steps

A number of flowcharts are provided in order to illustrate processing or functional steps. Although these flowcharts define steps in particular orders to explain various features the steps may, in some cases, be able to be performed in a different order. Furthermore, in some cases one or more steps may be combined into a single step, a single step may be divided into multiple separate steps, and/or the function(s) achieved by one or more of the described/illustrated steps may be achieved by one or more alternative steps.

Furthermore, while each flowchart has been described as a part of a single application the processing steps described may be implemented by different applications. The processing steps may be implemented by/embodied in software, firmware, hardware or a combination thereof.

The disclosure of the embodiments is intended to be illustrative, but not limiting, of the full scope of the embodiments, which is set forth in the following claims.

It will be understood that the invention disclosed and defined in this specification extends to all alternative combinations of two or more of the individual features mentioned or evident from the text or drawings. All of these different combinations constitute various alternative aspects of the invention.

1. A payment device comprising:
visible account details displayed on the payment device;
a processor;
a communications module; and
non-transient memory, the non-transient memory storing hidden account data in respect of a hidden payment account, the hidden payment account having at least one account detail that is different to the visible account details, the non-transient memory further storing instructions which, when executed by the processor, cause the processor to perform operations comprising:
detecting an activation event; and
in response to detecting the activation event, operating the communications module to transmit the hidden account data to an electronic device.

2. The payment device of claim 1, wherein in response to detecting the activation event the operations further comprise:
generating authentication data; and
operating the communications module to transmit the authentication data to the electronic device.

3. The payment device of claim 1, wherein the non-transient memory further stores the visible account details, and in response to detecting the activation event the operations further comprise:
operating the communications module to transmit the visible account details to the electronic device.

4. The payment device of claim 1, wherein the visible account details are valid credit card account details.

5. The payment device of claim 1, wherein the hidden account data comprises hidden account details selected from a group comprising: an account number; an account name; an expiry date.

6. The payment device of claim 1, wherein the hidden account data comprises one or more payment account tokens, the one or more payment account tokens usable to retrieve hidden account details selected from a group comprising: an account number; an account name; an expiry date.

7. The payment device of claim 1, wherein the payment device is a credit card.

8. A computer implemented method for operating an electronic device, the method comprising:
receiving payment device data from a payment device;
preparing credit card payment account details based on the payment device data;
transmitting the credit card payment account details to a merchant ecommerce system to effect payment for a transaction; and
transmitting a customer transaction message to a transaction recordal system, the customer transmitted transaction message comprising details in respect of the transaction.

9. (canceled)

10. (canceled)

11. The computer implemented method of claim 8, wherein the payment device data comprises one or more payment account tokens, and wherein preparing credit card payment account details based on the payment device data comprises using the one or more payment account tokens to access credit card payment account details selected from a group comprising: an account number; an account name; an expiry date.

12. The computer implemented method of claim 8, further comprising:
entering and displaying non-payment details into visibly displayed account detail fields, the non-payment details being different to the payment account details.

13. (canceled)

14. The computer implemented method of claim 8, wherein the credit card payment account details are not visibly displayed on the payment device.

15. An electronic device comprising:
a processing unit;
one or more communications interfaces; and
a computer-readable storage medium having stored therein instructions which, when executed by the processor, cause the processing unit to perform operations comprising:
receiving, via one of the one or more communications interfaces, payment device data from a payment device;
preparing credit card payment account details based on the payment device data;
transmitting, via one of the one or more communications interfaces, the credit card payment account details to a merchant ecommerce system to effect payment for a transaction; and
transmitting, via one of the one or more communications interfaces, a customer transaction message to a transaction recordal system, the customer transmitted transaction message comprising details in respect of the transaction.

16. (canceled)

17. (canceled)

18. The electronic device of claim 15, wherein the payment device data comprises one or more payment account tokens, and wherein preparing credit card payment account details based on the payment device data comprises using the one or more payment account tokens to access credit card payment account details selected from a group comprising: an account number; an account name; an expiry date.

19. The electronic device of claim 15, wherein the operations further comprise:
entering and displaying non-payment details into visibly displayed account detail fields, the non-payment details being different to the credit card payment account details.

20. (canceled)

21. The electronic device of claim 15, wherein the credit card payment account details are not visibly displayed on the payment device.

22. A computer implemented method for operating a computer system, the method comprising:
receiving a payment request, the payment request comprising transaction details in respect of a transaction for which payment is being requested;
determining whether the transaction is a verifiable transaction;
in response to determining the transaction is a verifiable transaction, generating and transmitting a verification request to a transaction recordal server, the verification request being in respect of the transaction and comprising data related to the transaction;
receiving a verification response from the transaction recordal server; and
at least partly in response to the verification response indicating the transaction is verified, causing the payment requested in the payment request to be made.

23. The computer implemented method of claim 22, wherein the transaction details comprise a payment account number, and wherein determining whether the transaction is a verifiable transaction is based on the payment account number.

24. (canceled)

25. The computer implemented method of claim 23, wherein the payment account number comprises an issuer identification number, and wherein a transaction is determined to be a verifiable transaction if the issuer identification number falls within a defined range of issuer identification numbers for which transactions can be verified.

26. (canceled)

27. A computer system comprising:
a processing unit; and
a computer-readable storage medium having stored therein instructions which, when executed by the processor, cause the processing unit to perform operations comprising:
receiving a payment request, the payment request comprising transaction details in respect of a transaction for which payment is being requested;
determining whether the transaction is a verifiable transaction;
in response to determining the transaction is a verifiable transaction, generating and transmitting a verification request to a transaction recordal server, the verification request being in respect of the transaction and comprising data related to the transaction;
receiving a verification response from the transaction recordal server; and
at least partly in response to the verification response indicating the transaction is verified, causing the payment requested in the payment request to be made.

28. The computer system of claim 27, wherein the transaction details comprise a payment account number, and wherein determining whether the transaction is a verifiable transaction is based on the payment account number.

29. (canceled)

30. The computer system of claim 28, wherein the payment account number comprises an issuer identification number, and wherein a transaction is determined to be a verifiable transaction if the issuer identification number falls within a defined range of issuer identification numbers for which transactions can be verified.

31. (canceled)

32. A method of operating payment device, the method comprising:
detecting an activation event; and
in response to detecting the activation event, transmitting hidden account data stored on the payment device to an electronic device, the hidden account data being in respect of a hidden payment account, the hidden payment account having at least one account detail that is different to visible account details displayed on the payment device.

33. The method of claim 32, wherein in response to detecting the activation event the method further comprises:
generating authentication data; and
transmitting the authentication data to the electronic device.

34. The method of claim 32, wherein method further comprises transmitting visible account details to the electronic device, the visible account details being displayed on the payment device.

35. The method of claim 32, wherein the visible account details are valid credit card account details.

36. The method of claim 32, wherein the hidden account data comprises hidden account details selected from a group comprising: an account number; an account name; an expiry date.

37. The method of claim 32, wherein the hidden account data comprises one or more payment account tokens, the one or more payment account tokens usable to retrieve hidden account details selected from a group comprising: an account number; an account name; an expiry date.

38. The method of claim 32, wherein the payment device is a credit card.
